(19) United States
(12) Patent Application Publication
(10) Pub. No.: US 2026/0359041 A1
(43) Pub. Date: Nov. 12, 2026

(54) COMPUTER PROGRAM CODE ANALYSIS

(71) Applicant: Alipay (Hangzhou) Digital Service Technology Co., Ltd, Hangzhou (CN)

(72) Inventors: Gang FAN, Hangzhou (CN); Xiaoheng XIE, Hangzhou (CN); Yinan LIANG, Hangzhou (CN); Shijie LI, Hangzhou (CN); Haokun LI, Hangzhou (CN); Xinyu CHEN, Hangzhou (CN); Peng DI, Hangzhou (CN); Xiao XIAO, Hangzhou (CN)

(21) Appl. No.: 19/722,461

(22) Filed: Jun. 26, 2026

Related U.S. Application Data
(63) Continuation of application No. PCT/CN2024/128976, filed on Oct. 31, 2024.

(30) Foreign Application Priority Data
Dec. 29, 2023 (CN) 202311873768.5

(51) Int. Cl. G06F 8/75; G06F 16/215

(52) U.S. Cl. CPC G06F 8/75; G06F 16/215

(57) ABSTRACT

Implementations of the present specification provide a computer program code analysis method and apparatus. The computer program code analysis method includes: in a process of performing computer program code analysis on a computer program code, first obtaining an analysis task for performing computer program code analysis on the computer program code; then determining, in a relational database based on a code structure type corresponding to the analysis task, a data table that stores code structure data of the computer program code in the code structure type; reading code structure data and a data structure relationship from the data table, to obtain the code structure data and the data structure relationship; and finally performing analysis processing on the code structure data and the data structure relationship in a computer program code analysis manner corresponding to the analysis task, to obtain a computer program code analysis result.

### CROSS-REFERENCE TO RELATED APPLICATION

The present application is a continuation of PCT Application No. PCT/CN2024/128976, filed on Oct. 31, 2024, which claims priority benefit to Chinese Patent Application No. 202311873768.5, filed on Dec. 29, 2023, which are all incorporated herein by reference in their entirety for all purposes.

### TECHNICAL FIELD

This document relates to the field of data processing technologies, and in particular, to computer program code analysis.

### BACKGROUND

With development of the Internet, in an Internet based application development process, different Internet services are encoded and implemented using proper programming languages. To ensure accuracy and effective running of written computer program code, the computer program code is analyzed to detect whether there is a problem in the computer program code. Different analysis tasks need different analysis algorithms for computer program code analysis.

### SUMMARY

One or more implementations of the present specification provide a computer program code analysis method. The computer program code analysis method includes: obtaining an analysis task for performing computer program code analysis on a computer program code; determining, in a relational database based on a code structure type corresponding to the analysis task, a data table that stores code structure data of the computer program code in the code structure type; reading code structure data and a data structure relationship from the data table, to obtain the code structure data and the data structure relationship; and performing analysis processing on the code structure data and the data structure relationship in a computer program code analysis manner corresponding to the analysis task, to obtain a computer program code analysis result.

One or more implementations of the present specification provide a computer program code analysis apparatus, including: an analysis task acquisition module, configured to obtain an analysis task for performing computer program code analysis on a computer program code; a data table determining module, configured to determine, in a relational database based on a code structure type corresponding to the analysis task, a data table that stores code structure data of the computer program code in the code structure type; a code structure data reading module, configured to read code structure data and a data structure relationship from the data table, to obtain the code structure data and the data structure relationship; and an analysis processing module, configured to perform analysis processing on the code structure data and the data structure relationship in a computer program code analysis manner corresponding to the analysis task, to obtain a computer program code analysis result.

One or more implementations of the present specification provide a computer program code analysis device, including: a processor and a storage configured to store computer-executable instructions. The computer-executable instructions are executed to cause the processor to perform the following procedure: obtaining an analysis task for performing computer program code analysis on a computer program code; determining, in a relational database based on a code structure type corresponding to the analysis task, a data table that stores code structure data of the computer program code in the code structure type; reading code structure data and a data structure relationship from the data table, to obtain the code structure data and the data structure relationship; and performing analysis processing on the code structure data and the data structure relationship in a computer program code analysis manner corresponding to the analysis task, to obtain a computer program code analysis result.

One or more implementations of the present specification provide a storage medium, configured to store computer-executable instructions. The computer-executable instructions are executed by a processor to implement the following procedure: obtaining an analysis task for performing computer program code analysis on a computer program code; determining, in a relational database based on a code structure type corresponding to the analysis task, a data table that stores code structure data of the computer program code in the code structure type; reading code structure data and a data structure relationship from the data table, to obtain the code structure data and the data structure relationship; and performing analysis processing on the code structure data and the data structure relationship in a computer program code analysis manner corresponding to the analysis task, to obtain a computer program code analysis result.

### BRIEF DESCRIPTION OF DRAWINGS

To describe the technical solutions in one or more implementations of the present specification or in the related technologies more clearly, the following is a brief introduction of the accompanying drawings for illustrating such technical solutions. Clearly, the accompanying drawings described below are merely some implementations of the present specification, and a person of ordinary skill in the art can derive other drawings from such accompanying drawings without making creative efforts.

FIG. 1 is a schematic diagram illustrating an implementation environment of a computer program code analysis method according to one or more implementations of the present specification;

FIG. 2 is a processing flowchart illustrating a computer program code analysis method according to one or more implementations of the present specification;

FIG. 3 is a schematic architecture diagram illustrating a computer program code analysis method according to one or more implementations of the present specification;

FIG. 4 is a processing flowchart illustrating a computer program code analysis method applied to a call analysis scenario according to one or more implementations of the present specification;

FIG. 5 is a processing flowchart illustrating a computer program code analysis method applied to an exception analysis scenario according to one or more implementations of the present specification;

FIG. 6 is a schematic diagram illustrating an implementation of a computer program code analysis apparatus according to one or more implementations of the present specification; and

FIG. 7 is a schematic structural diagram illustrating a computer program code analysis device according to one or more implementations of the present specification.

### DESCRIPTION OF EMBODIMENTS

To enable a person skilled in the art to better understand technical solutions in one or more implementations of the present specification, the following clearly and comprehensively describes the technical solutions in the one or more implementations of the present specification with reference to the accompanying drawings in the one or more implementations of the present specification. Clearly, the described implementations are merely some rather than all of the implementations of the present specification. Based on the one or more implementations of the present specification, all other implementations obtained by a person of ordinary skill in the art without creative efforts shall fall within the protection scope of this document.

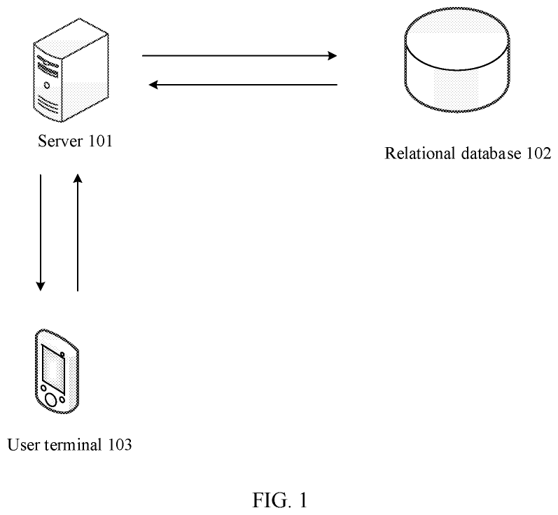

A computer program code analysis method provided in one or more implementations of the present specification can be applied to an implementation environment of computer program code analysis. As shown in FIG. 1, the implementation environment includes at least a server 101 and a relational database 102.

The server 101 can be one or more servers, a server cluster including several servers, or a cloud server of a cloud computing platform. The server 101 is configured to perform computer program code analysis on a computer program code based on a data table that is stored in the relational database 102 and that stores code structure data of the computer program code in a code structure type.

The relational database 102 stores the data table that stores the code structure data of the computer program code in the code structure type.

In addition, the implementation environment can further include a user terminal 103. The user terminal 103 can be a smartphone, a tablet computer, an e-book reader, a wearable device, a device that performs information exchange based on augmented reality (AR)/virtual reality (VR), or the like. An application or a browser can be further installed. A user submits an analysis instruction and receives and displays a computer program code analysis result by using the application or the browser.

In this implementation environment, the user submits, to the server 101 by using the user terminal 103, the analysis instruction for performing computer program code analysis on the computer program code. The server 101 first obtains an analysis task for performing computer program code analysis on the computer program code; then determines, in the relational database 102 based on a code structure type corresponding to the analysis task, a data table that stores code structure data of the computer program code in the code structure type; reads code structure data and a data structure relationship from the data table, to obtain the code structure data and the data structure relationship; and finally performs analysis processing on the code structure data and the data structure relationship in a computer program code analysis manner corresponding to the analysis task, to obtain a computer program code analysis result.

One or more implementations of a computer program code analysis method provided in the present specification are as follows:

According to the computer program code analysis method provided in this implementation, in a computer program code analysis process, based on a code structure type corresponding to an analysis task for performing computer program code analysis on a computer program code, a data table that stores code structure data of the computer program code in the code structure type is determined in a relational database; then code structure data and a data structure relationship are read from the data table, to obtain the code structure data and the data structure relationship; and analysis processing is performed based on the code structure data and the data structure relationship, to obtain a computer program code analysis result. As such, the computer program code is converted into standardized relational data to be stored in the data table, and computer program code analysis is performed based on the relational data, thereby improving computer program code analysis efficiency. Compared with the computer program code, data has a high degree of determinacy, and converting a computer program code analysis task of the computer program code into a data analysis task improves computer program code analysis accuracy.

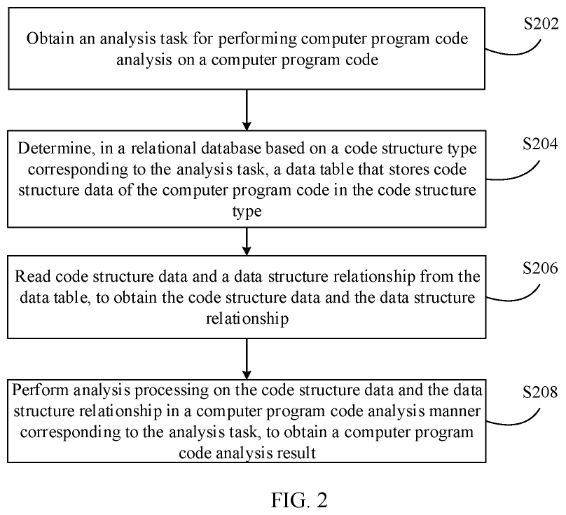

Referring to FIG. 2, in some implementations, a computer program code analysis method provided in this implementation includes step S202 to step S208.
Step S202: Obtain an analysis task for performing computer program code analysis on a computer program code.

In practice, computer program code analysis has different analysis requirements in different analysis scenarios. For example, in a code security analysis scenario, whether there is a vulnerability concern in the computer program code is to be analyzed. In a code instruction analysis scenario, accuracy of the computer program code is to be analyzed. In a code call analysis scenario, whether a call function is called normally is to be analyzed.

Corresponding to the different analysis requirements, in a process of performing computer program code analysis on the computer program code, different analysis tasks are submitted to implement computer program code analysis for the different analysis requirements, for example, a vulnerability analysis task, a call analysis task, or a quality analysis task.

In some implementations, a user submits an analysis instruction for performing computer program code analysis on the computer program code, where the analysis instruction includes an analysis task, and computer program code analysis is performed on the computer program code based on the analysis task.

To improve convenience for the user to submit the analysis instruction, the user can write the analysis instruction in a high-level language. After the analysis instruction written in the high-level language is obtained, because a server cannot directly determine a data table in a relational database based on the analysis instruction in the high-level language or perform computer program code analysis, the analysis instruction written based on the high-level language is converted into an assembly language, to perform data table reading and computer program code analysis based on an analysis instruction in a low-level language.

In some implementations provided in this implementation, the analysis instruction that can be identified by the server is obtained in the following manner: obtaining instruction code corresponding to an interface call instruction for performing computer program code analysis on the computer program code, where, the instruction code is written based on a first program language; performing code conversion on the instruction code to obtain analysis instruction code that includes the analysis task, where, the analysis instruction code is in a second program language; and determining the analysis task based on the analysis instruction code.

In some implementations, the first program language includes a language providing an instruction or a statement that is required to write the computer program code and that is close to a user language, for example, a Gödel language. A second program language includes a language that provides a capability of operating underlying hardware of a computer system, for example, Datalog (data query language). The Gödel language can be a high-level language corresponding to Datalog.

In some implementations, different interfaces are called based on different analysis requirements to perform computer program code analysis on the computer program code. Therefore, first, instruction code corresponding to an interface call instruction that is for performing interface call on a target interface and that is written in a high-level language is obtained, then, code conversion is performed on the instruction code to obtain analysis instruction code that is in a low-level language and that includes an analysis task corresponding to the target interface, and finally, the analysis task included in the analysis instruction code is read.

For example, the user writes, based on Gödel language, instruction code for performing call analysis on the computer program code, to perform computer program code analysis on the computer program code by calling an analysis interface. After the instruction code is obtained, code conversion is performed on the instruction code to obtain analysis instruction code in a Datalog form, and an analysis task for performing call analysis on the computer program code is read from the analysis instruction code.

The obtaining the instruction code corresponding to the interface call instruction for performing computer program code analysis on the computer program code can be further replaced with obtaining instruction code corresponding to a user analysis instruction for performing computer program code analysis on the computer program code, and forming a new implementation with another step.
Step S204: Determine, in a relational database based on a code structure type corresponding to the analysis task, a data table that stores code structure data of the computer program code in the code structure type.

After the analysis task for performing computer program code analysis on the computer program code is obtained, a computer program code analysis task is converted into a data analysis task, and computer program code analysis is implemented through data analysis processing, to obtain a computer program code analysis result. Therefore, in this step, based on the code structure type corresponding to the analysis task, the data table that stores the code structure data of the computer program code in the code structure type is determined in the relational database.

In some implementations, a code structure relationship is abstracted from at least one dimension. An abstract dimension can be a code structure type. For example, a structure relationship is abstracted from a syntax dimension, e.g., an abstract syntax type. For example, a structure relationship is abstracted from a semantic dimension, e.g., an abstract semantic type. For example, a structure relationship is abstracted from a function call dimension, e.g., a function call type. In addition, a control flow type, a program dependency type, a class inheritance type, a document/comment information type can be included.

In some implementations, after a code structure relationship is abstracted from at least one dimension, a structure relationship in each code structure type is represented by using a reference data table in each code structure type. In this implementation, to perform computer program code analysis based on an analysis task for performing computer program code analysis on the computer program code, a corresponding code structure type is configured for the analysis task, to perform computer program code analysis based on code structure data of the computer program code in the corresponding code structure type.

In some implementations, when the computer program code is obtained, a data table of the computer program code in each code structure type can be generated in advance, e.g., a data table that stores code structure data of the computer program code in each code structure type can be generated in advance for each code structure type. In a process of performing computer program code analysis on the computer program code, a data table for performing the computer program code analysis is determined based on a code structure type corresponding to an analysis task for the computer program code analysis. After the analysis task for performing computer program code analysis on the computer program code is obtained, the data table that stores the code data structure of the computer program code in the code structure type corresponding to the analysis task can be further generated.

The following separately describes generation of the data table that stores the code structure data of the computer program code in the code structure type in detail.

In some implementations provided in this implementation, before the data table that stores the code structure data of the computer program code in the code structure type is determined in the relational database, the data table can be generated in the following manner: reading a reference data table pre-created in each code structure type; based on a data category of the reference data table, reading code structure data from the computer program code and writing the code structure data into the corresponding reference data table, to obtain a data table in each code structure type; and storing the data table in each code structure type in the relational database.

In some implementations, after the computer program code is obtained, the reference data table pre-created in each code structure type is read, then the computer program code is written into the reference data table to obtain the data table in each code structure type, and finally the data table in each code structure type is stored in the relational database.

For example, a reference data table for an abstract syntax tree, a reference data table for an abstract semantic graph, and a reference data table for a function call graph are pre-created. After the computer program code is obtained, the reference data table for the abstract syntax tree, the reference data table for the abstract semantic graph, and the reference data table for the function call graph are read, and based on a node category of each node in the reference data table for the abstract syntax tree, code structure data is read from the computer program code and is written into the reference data table, to obtain a data table that stores the code structure data of the computer program code in the abstract syntax type. Similarly, a data table that stores code structure data of the computer program code in the abstract semantic type and a data table that stores code structure data of the computer program code in a function call type are obtained. Then, the three data tables mentioned above are stored in the relational database, so that after the analysis task for performing computer program code analysis on the computer program code is obtained, the data table that stores the code structure data of the computer program code in the code structure type corresponding to the analysis task is determined in the relational database.

In some implementations provided in this implementation, after the analysis task for performing computer program code analysis on the computer program code is obtained, the data table can be generated in the following manner: obtaining an analysis instruction for performing computer program code analysis on the computer program code; reading an analysis task included in the analysis instruction, and determining a code structure type corresponding to the analysis task; and writing data into a plurality of reference data tables in the code structure type based on the computer program code, to obtain data tables in the code structure type, and storing the data tables in the relational database.

In some implementations, a corresponding code structure type is read based on the analysis task included in the analysis instruction for performing computer program code analysis on the computer program code, and then the computer program code is written into a reference data table in the code structure type, to obtain a data table that stores code structure data of the computer program code in the code structure type. Because the data table is stored in a corresponding relational database after being generated, a data table that stores code structure data of the computer program code in the code structure type is obtained, to determine, in the relational database, the data table that stores the code structure data of the computer program code in the code structure type.

For example, if the analysis task for performing computer program code analysis on the computer program code is obtained as a call analysis task, and a code structure type corresponding to the call analysis task is read as a function call type, a reference data table in the function call type is read, and based on a node category of each node in the reference data table, program structure data is read from the computer program code and the program structure data is written to the reference data table, to obtain a data table that stores code structure data of the computer program code in the function call type.

In some implementations, step S204 can be further replaced with generating, based on the computer program code and a reference data table in a code structure type corresponding to the analysis task, a data table that stores code structure data of the computer program code in the code structure type, and forming a new implementation with another processing step provided in this implementation.

In some implementations, for a code structure type, one data table can be configured to store code structure data in each node type. In this implementation, a plurality of reference data tables can be configured for a code structure type. In some implementations, there are a plurality of node categories in the code structure type, and one node category corresponds to one reference data table. When there are a plurality of reference data tables in one code structure category, in some implementations, there are a plurality of data tables.

When there are a plurality of data tables, in some implementations provided in this implementation, the code structure data in the data table is written in the following manner: reading a plurality of reference data tables in the code structure type; and based on a data category of each of the plurality of reference data tables, reading code structure data from the computer program code and writing the code structure data into each reference data table.

In some implementations, the data table that stores the code structure data of the computer program code in the code structure type includes a plurality of data tables. In a process of writing code structure data in the plurality of data tables, based on a data category of each of the plurality of reference data tables in the code structure type, code structure data is read from the computer program code and is written into each reference data table, to obtain the plurality of data tables in the code structure type.

It should be noted that, for a plurality of reference data tables in each code structure type, the above can be used to write the code structure data. It should be further noted that the code structure data of the computer program code in the code structure type is determined based on the code structure type. For example, if the code structure type is an abstract syntax type, code structure data of the computer program code in the abstract syntax type is determined based on each node category in the abstract syntax type.

In some implementations, a field relationship in each of the plurality of data tables is determined based on a field structure configuration of the code structure type; and a table relationship between the plurality of data tables is determined based on a code structure configuration of the code structure type.

In an example execution process, a plurality of code categories, e.g., a plurality of fields, may exist in a data table. A relationship between a plurality of fields stored in a same data table is determined based on a field structure configuration, e.g., a syntax structure. A plurality of data tables in a same code structure category represent a code structure by using a table relationship, and a table relationship between the plurality of data tables is determined based on a snippet structure relationship of each code snippet in a key computer program code selected for the code structure type. That is, the field structure configuration includes the syntax structure; and the code structure configuration includes the snippet structure relationship of the code snippet.

The following describes creation of the plurality of reference data tables in the code structure type in detail.

In some implementations provided in this implementation, the plurality of reference data tables in the code structure type are created in the following manner: performing code extraction in a source computer program code based on the code structure type to obtain a key computer program code; extracting a code category of each code snippet in the key computer program code, and creating the plurality of reference data tables based on the code category; and constructing a table relationship between the plurality of reference data tables based on a snippet structure relationship of each code snippet in the source computer program code.

In some implementations, in a process of extracting the code category of each code snippet in the key computer program code, and creating the plurality of reference data tables based on the code category, deduplication processing is first performed on the code category to obtain a key code category; and then combination processing is performed on the key code category based on a syntax structure, to obtain at least one data category, and a reference data table of each of the at least one data category is created.

In some implementations, in a process of configuring the reference data table in the code structure type, first, code extraction is performed in the source computer program code to obtain the key computer program code; then, code categories of all code snippets in the key computer program code are extracted, and the code categories are deduplicated and combined to obtain at least one data category; a reference data table corresponding to each data category is created; and on the basis of obtaining the reference data table corresponding to each data category, a table relationship between a plurality of reference data tables is constructed based on a snippet structure relationship of the data category of the reference data table in the source computer program code. Therefore, the creation of the reference data table in the code structure type is completed.

For example, in a process of configuring a reference data table in an abstract syntax type, the key computer program code includes an “if” statement and a “for” statement, the “if” statement includes a “then” statement and an “else” statement, and the “for” statement further includes a “loop” statement. In this case, a code category of each line of code is extracted, to obtain five code categories: if, then, else, for, and loop. However, configuring a reference data table for each of these five code categories leads to an excessive number of reference data tables. Therefore, the code categories are combined based on a syntax structure to obtain two data categories: if and for. In this case, a reference data table for the “if” data category and a reference data table for the “for” data category are created. In the key computer program code, code corresponding to the “if” statement is executed before code corresponding to the “for” statement. In this case, the reference data table for the “if” data category is determined as a parent data table of the reference data table for the “for” data category, and correspondingly, the reference data table for the “for” data category is a child data table of the reference data table for the “if” data category. It should be further noted that the reference data table for the “if” data category includes an “if” field, a “then” field, and an “else” field. A field relationship between the “if” field, the “then” field, and the “else” field can be generated based on a syntax structure of the “if” statement.

The process of creating the reference data table in the abstract syntax type is merely an example. In a process of actually creating a reference data table for a code structure category, the reference data table can be created based on an actual requirement and a service configuration. This is not limited in this implementation.

In this implementation, a Java abstract syntax tree (AST) is used as an example. The AST includes 162 nodes of different types, and 162 reference data tables are included. In the manner, unstructured data can be organized into structured relational data.

It should be noted that in the process of performing code extraction in the source computer program code, code extraction can be performed based on a preconfigured extraction policy, or code extraction can be performed by a user. This is not limited in this implementation.

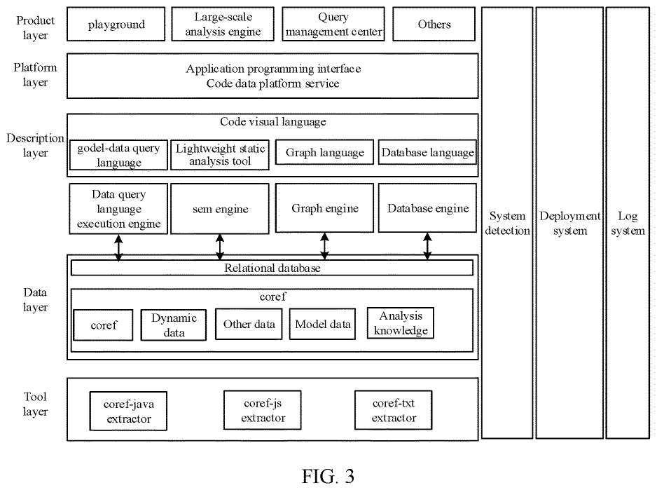

A schematic architectural diagram shown in FIG. 3 includes a tool layer, a data layer, a description layer, a platform layer, and a product layer. The tool layer includes extractors for performing code extraction in different programming languages, such as coref-java extractor, coref-js extractor, and coref-txt extractor, which are used to perform code extraction on original computer program code in different programming languages. The data layer includes a coref model and a relational database that are used to generate reference data tables in different code structure types, and can further store dynamic data, other data, model data, and analysis knowledge. The description layer includes analysis tools and supporting languages for performing analysis processing on different analysis tasks based on a data table in a corresponding code structure type, for example, a code visual language (codelnsight language) of the description layer includes godel-datalog, semgrep (lightweight static analysis tool), a graph language, and a structured query language (SQL); and correspondingly, further includes a datalog execution engine, a sem engine, a graph engine, and a database engine. The platform layer includes open application programming interface (API) and sparrow (code data platform) services. The product layer includes playground, a large-scale analysis engine, a query management center, and others. This architecture can also correspond to system detection, a deployment system, and a log system.
Step S206: Read code structure data and a data structure relationship from the data table, to obtain the code structure data and the data structure relationship.

In the step, the data table that stores the code structure data of the computer program code in the code structure type is determined in the relational database. In this step, the code structure data and the data structure relationship are read from the data table, to obtain the code structure data and the data structure relationship.

In some implementations, the code structure data and the data structure relationship can be read from the data table based on the analysis task, to obtain the code structure data and the data structure relationship.

In an example execution process, code structure data and a data structure relationship can be read from the data table based on the analysis task, to obtain a global code structure data and data structure relationship, or code structure data and a data structure relationship can be read from the data table based on a local data identifier included in the analysis task, to obtain local code structure data and data structure relationship. In some implementations, because analysis tasks are different, analysis objects are also different. For example, in a process of performing analysis processing on a call function, only call data and called data of the call function are to be analyzed. However, all code structure data is to be analyzed during code exception analysis.

Therefore, code data and a data structure relationship are read from the data table based on an analysis object of the analysis task, to obtain the code structure data and the data structure relationship. In some implementations, analysis tasks are different, and analysis objects are also different. If the analysis task is a call analysis task, the analysis object is a local analysis object. In some implementations provided in this implementation, if the analysis task is a call analysis task, in a process of reading the code structure data and the data structure relationship from the data table, to obtain the code structure data and the data structure relationship, the following operations is performed: reading call data and called data from a function call data table of the computer program code in a function call type based on a call function identifier included in the call analysis task; and constructing a data call relationship between the call data and the called data based on a call relationship between the call data and the called data in the function call data table.

In some implementations, if the analysis task is a call analysis task of any call function, the call data and the called data are read from the function call data table of the computer program code in the function call type based on the call function identifier included in the call analysis task, and the data call relationship between the call data and the called data is constructed based on a table relationship between a data table that stores the call data and a data table that stores the called data in the function call data table.

If the analysis task is an exception analysis task, In some implementations provided in this implementation, in a process of reading the code structure data and the data structure relationship from the data table, to obtain the code structure data and the data structure relationship, the following operations are performed: reading abstract syntax data from an abstract syntax data table of the computer program code in an abstract syntax type; and constructing a data structure relationship of the abstract syntax data based on a table relationship of a data table to which the abstract syntax data belongs.

The above uses the call analysis task and the exception analysis task as examples to describe in detail a process of reading the code structure data and the data structure relationship from the data table, to obtain the code structure data and the data structure relationship. For another analysis task, a process of reading code structure data and a data structure relationship from a data table, to obtain the code structure data and the data structure relationship is similar to the method. Details are omitted in this implementation.

In addition, step S206 can be further replaced with reading code structure data and a data structure relationship from a data table, to obtain the code structure data having the data structure relationship, and forming a new implementation with another processing step provided in this implementation.
Step S208: Perform analysis processing on the code structure data and the data structure relationship in a computer program code analysis manner corresponding to the analysis task, to obtain a computer program code analysis result.

In some implementations, computer program code analysis is converted into data analysis, and a computer program code analysis result is generated based on a data analysis result, thereby improving computer program code analysis accuracy.

In some implementations, after the code structure data and the data structure relationship are obtained, analysis processing is performed on the code structure data and the data structure relationship in the computer program code analysis manner corresponding to the analysis task, to obtain the computer program code analysis result.

In an example execution process, analysis processing can be performed on the code structure data and the data structure relationship in two analysis manners: static computer program code analysis and dynamic computer program code analysis. In some implementations, whether analysis processing is performed through static computer program code analysis or dynamic computer program code analysis can be determined based on an analysis task.

In some implementations provided in this implementation, if the computer program code analysis manner corresponding to the analysis task is a static analysis manner, in a process of performing analysis processing on the code structure data and the data structure relationship, to obtain the computer program code analysis result, the following operations are performed: reading a computer program code analysis policy corresponding to the analysis task; performing static computer program code analysis on the code structure data and the data structure relationship based on the computer program code analysis policy, to obtain a static computer program code analysis result; and generating the computer program code analysis result of the computer program code based on the static computer program code analysis result.

In some implementations, in a static computer program code analysis process, a computer program code analysis policy is to be configured, and a static analysis result is determined by comparing the code structure data and the data structure relationship with a reference analysis condition in the computer program code analysis policy, and a computer program code analysis result of the computer program code is generated based on the static analysis result.

For example, if the analysis task is a quality analysis task, code structure data and a data structure relationship are read from a data table that is in a relational database and that stores code structure data of computer program code in a document/comment information type, to obtain a line number and a comment of each line of code in the computer program code, and a correlation between the comment of each line of code and a corresponding comment in a reference comment library is calculated. If the correlation does not satisfy a preset condition, a corresponding line number and comment are used as a static analysis result, and the static analysis result is used as a computer program code analysis result.

In some implementations provided in this implementation, if the computer program code analysis manner corresponding to the analysis task is a dynamic analysis manner, in a process of performing analysis processing on the code structure data and the data structure relationship, to obtain the computer program code analysis result, the following operations are performed: performing code simulation running based on the code structure data and the data structure relationship; and generating the computer program code analysis result of the computer program code based on a running result of the code simulation running.

In some implementations, code simulation running is performed based on the code structure data and the data structure relationship, and a computer program code analysis result is generated based on a running result.

For example, if the analysis task is a call analysis task, code structure data and a data structure relationship are read from a data table that is in a relational database and that stores code structure data of computer program code in a function call type, to obtain call data and called data of a call function that have a call relationship, simulated call is performed based on the call data and the called data, and a computer program code analysis result is generated based on a simulated call result.

It should be noted that the description of performing analysis processing based on static computer program code analysis and dynamic computer program code analysis is merely an example, and analysis processing can be further performed on the code structure data and the data structure relationship in another computer program code analysis manner. This is not limited in this implementation.

In addition, step S208 can be further replaced with performing computer program code analysis processing of the analysis task on the code structure data and the data structure relationship, to obtain a computer program code analysis result, and forming a new implementation with another processing step provided in this implementation.

In conclusion, in one or more computer program code analysis methods provided in this implementation, first, the reference data table in each code structure type is configured based on the source computer program code. In some implementations, the key computer program code in each code structure type is extracted from the source computer program code, the code category of each code snippet in the key computer program code is extracted for the key computer program code in each code structure type, and a reference data table for each data category is created by using the code category as a data category. Then, a table relationship between reference data tables is constructed based on a snippet structure relationship of each code snippet in the key computer program code, which can be a snippet sequence relationship. Therefore, a reference data table including a plurality of reference data tables and the table relationship in each code structure type is obtained.

Then, after the computer program code is obtained, code structure data extraction is performed on the computer program code based on data categories of the plurality of reference data tables in each code structure type, and code structure data is written into a reference data table for a corresponding data category. As such, a data table that stores code program data of the computer program code in each code structure type is obtained and the data table is stored in a relational database. The code program data of the computer program code is stored in a form of the data table in the code structure type, to implement standardization and digitalization of the computer program code, and the computer program code is converted into standardized relational data to be stored in the relational database, so that a user can perform computer program code analysis based on an operation of the database, thereby improving convenience of computer program code analysis. Compared with a graph structure, the relational data is more easily computed with high performance. A data table stored in the relational database can be a graph structure or non-graph data. Compared with the computer program code, the data is more deterministic, and the relational data can fully and accurately store related information of the computer program code.

After the analysis task for performing computer program code analysis on the computer program code is obtained, based on the code structure type corresponding to the analysis task, the data table that stores the code structure data of the computer program code in the code structure type is determined in the relational database; the code structure data and the data structure relationship are read from the data table, to obtain the code structure data and the data structure relationship; and analysis processing is performed on the code structure data and the data structure relationship, to obtain the computer program code analysis result. Therefore, computer program code analysis is converted into data analysis, thereby improving accuracy and validity of computer program code analysis.

In addition, in one or more computer program code analysis methods provided in this implementation, computer program code analysis can be further performed in an interface call manner. In some implementations, an analysis task for performing computer program code analysis on a computer program code is obtained; based on a code structure type corresponding to the analysis task, a data table that stores code structure data of the computer program code in the code structure type is determined in a relational database; code structure data and a data structure relationship are read from the data table, to obtain the code structure data and the data structure relationship; and an analysis processing structure corresponding to the analysis task is called and the code structure data and data structure relationship are passed into, to perform analysis processing on the code structure data and the data structure relationship, so as to obtain a computer program code analysis result.

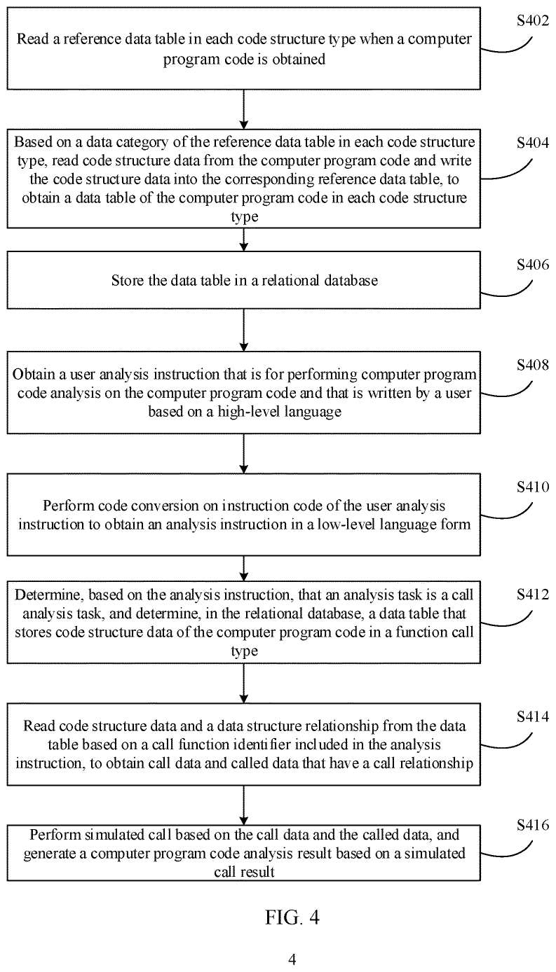

The following further describes, by using an example in which a computer program code analysis method provided in this implementation is applied to a call analysis scenario, the computer program code analysis method provided in this implementation. Referring to FIG. 4, in some implementations, the computer program code analysis method applied to the call analysis scenario includes the following steps.
Step S402: Read a reference data table in each code structure type when a computer program code is obtained.
Step S404: Based on a data category of the reference data table in each code structure type, read code structure data from the computer program code and write the code structure data into the corresponding reference data table, to obtain a data table of the computer program code in each code structure type.

In some implementations, the data table of the computer program code in each code structure type stores code structure data of the computer program code in a corresponding code structure type.
Step S406: Store the data table in a relational database.
Step S408: Obtain a user analysis instruction that is for performing computer program code analysis on the computer program code and that is written by a user based on a high-level language.

In some implementations, the high-level language can be an R&D data processing language Gödel language.
Step S410: Perform code conversion on instruction code of the user analysis instruction to obtain an analysis instruction in a low-level language.

In some implementations, the low-level language can be a Datalog language.
Step S412: Determine, based on the analysis instruction, that an analysis task is a call analysis task, and determine, in the relational database, a data table that stores code structure data of the computer program code in a function call type.
Step S414: Read code structure data and a data structure relationship from the data table based on a call function identifier included in the analysis instruction, to obtain call data and called data that have a call relationship.
Step S416: Perform simulated call based on the call data and the called data, and generate a computer program code analysis result based on a simulated call result.

In addition, step S416 can be further replaced with inputting the call data and the called data into an analysis interface corresponding to the call analysis task, so as to perform analysis processing on the call data and the called data to obtain a computer program code analysis result.

In some implementations, step S412 to step S416 can be further replaced with determining an analysis task based on the analysis instruction, and determining, in a relational database based on a code structure type corresponding to the analysis task, a data table of the computer program code in the code structure type; reading code structure data and a data structure relationship from the data table to obtain the code structure data having the data structure relationship; and performing code simulation running based on the code structure data to obtain a simulation running result.

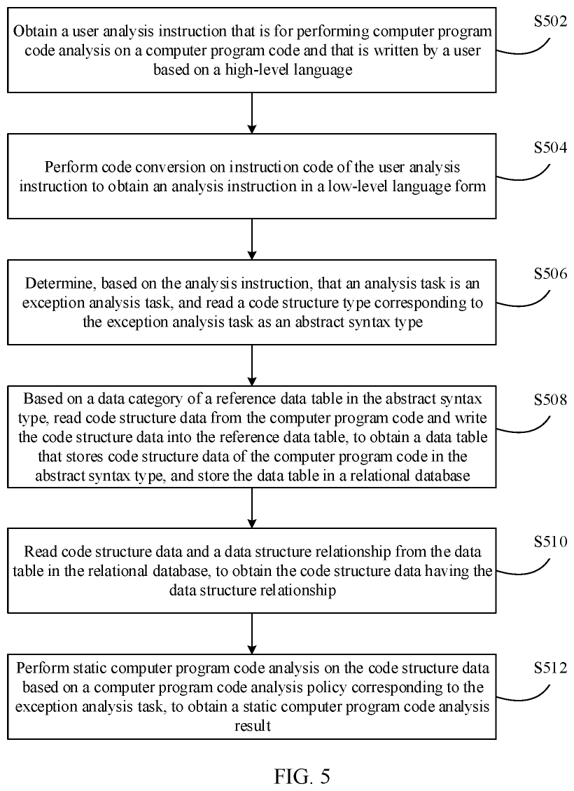

The following further describes, by using an example in which a computer program code analysis method provided in this implementation is applied to an exception analysis scenario, the computer program code analysis method provided in this implementation. Referring to FIG. 5, in some implementations, the computer program code analysis method applied to the exception analysis scenario includes the following steps.
Step S502: Obtain a user analysis instruction that is for performing computer program code analysis on a computer program code and that is written by a user based on a high-level language.

In some implementations, the high-level language can be an R&D data processing language Gödel language.
Step S504: Perform code conversion on instruction code of the user analysis instruction to obtain an analysis instruction in a low-level language.

In some implementations, the low-level language can be a Datalog language.
Step S506: Determine, based on the analysis instruction, that an analysis task is an exception analysis task, and read a code structure type corresponding to the exception analysis task as an abstract syntax type.
Step S508: Based on a data category of a reference data table of the abstract syntax type, read code structure data from the computer program code and write the code structure data into the reference data table, to obtain a data table that stores code structure data of the computer program code in the abstract syntax type, and store the data table in a relational database.
Step S510: Read code structure data and a data structure relationship from the data table in the relational database, to obtain the code structure data having the data structure relationship.
Step S512: Perform static computer program code analysis on the code structure data based on a computer program code analysis policy corresponding to the exception analysis task, to obtain a static computer program code analysis result.

In addition, step S512 can be further replaced with passing the obtained code structure data having the data structure relationship into an analysis interface corresponding to an exception analysis task, so as to perform analysis processing on the code structure data to obtain a computer program code analysis result.

In some implementations, step S506 to step S512 can be further replaced with determining an analysis task based on the analysis instruction, and reading a code structure type corresponding to the analysis task; based on a data category of a reference data table in the code structure type, reading code structure data from the computer program code and writing the code structure data into the reference data table, to obtain a data table that stores code structure data of the computer program code in the code structure type, and storing the data table in a relational database; reading code structure data and a data structure relationship from the data table in the relational database, to obtain the code structure data having the data structure relationship; and performing static computer program code analysis on the code structure data based on a computer program code analysis policy corresponding to the analysis task, to obtain a static computer program code analysis result.

One or more implementations of a computer program code analysis apparatus provided in the present specification are as follows: In the implementation, a computer program code analysis method is provided, and correspondingly, a computer program code analysis apparatus is further provided. Descriptions are provided below with reference to the accompanying drawings.

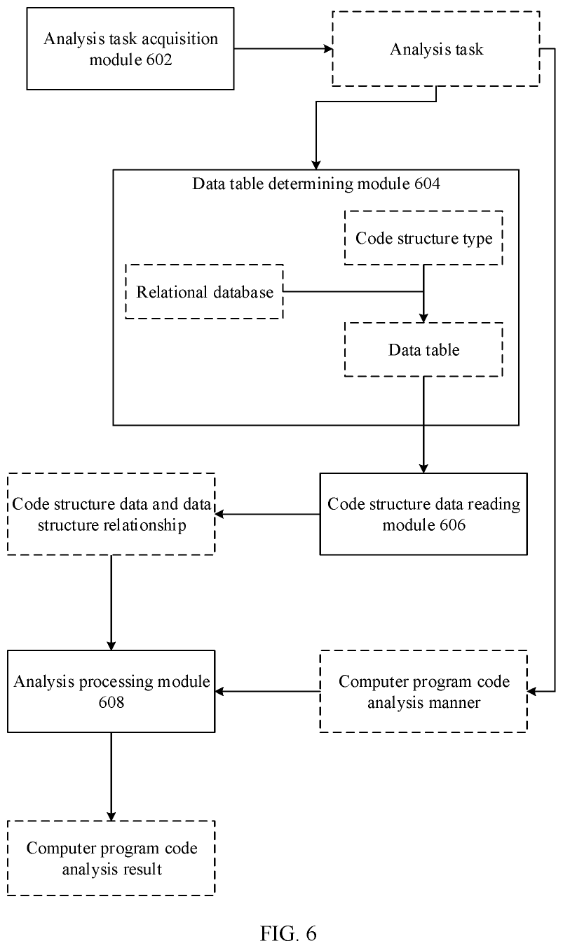

Referring to FIG. 6, FIG. 6 is a schematic diagram illustrating an implementation of a computer program code analysis apparatus according to this implementation.

The apparatus implementations correspond to the method implementations, and therefore are briefly described. For related parts, references can be made to corresponding descriptions of the method implementations provided above. The apparatus implementations described below are merely examples.

This implementation provides a computer program code analysis apparatus, including the following modules: an analysis task acquisition module 602, configured to obtain an analysis task for performing computer program code analysis on a computer program code; a data table determining module 604, configured to determine, in a relational database based on a code structure type corresponding to the analysis task, a data table that stores code structure data of the computer program code in the code structure type; a code structure data reading module 606, configured to read code structure data and a data structure relationship from the data table, to obtain the code structure data and the data structure relationship; and an analysis processing module 608, configured to perform analysis processing on the code structure data and the data structure relationship in a computer program code analysis manner corresponding to the analysis task, to obtain a computer program code analysis result.

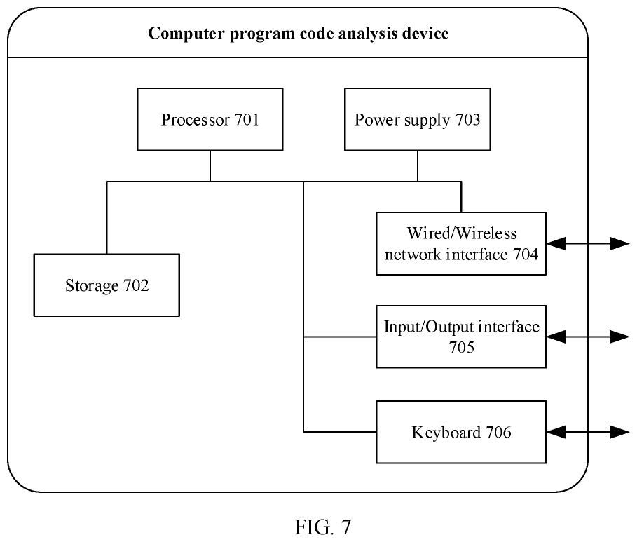

One or more implementations of a computer program code analysis device provided in the present specification are as follows: Corresponding to the described computer program code analysis method, based on a same technical concept, one or more implementations of the present specification further provide a computer program code analysis device. The computer program code analysis device is configured to perform the provided computer program code analysis method. FIG. 7 is a schematic structural diagram illustrating a computer program code analysis device according to one or more implementations of the present specification.

The computer program code analysis device provided in this implementation includes: As shown in FIG. 7, the computer program code analysis device can have large differences due to different configurations or performance, and can include one or more processors 701 and a storage 702. The storage 702 can store one or more storage applications or data. The storage 702 can be a temporary storage or a persistent storage. The application stored in the storage 702 can include one or more modules (not shown in the figure), and each module can include a series of computer-executable instructions in the computer program code analysis device. Further, the processor 701 can be configured to: communicate with the storage 702, and execute a series of computer-executable instructions in the storage 702 on the computer program code analysis device. The computer program code analysis device can further include one or more power supplies 703, one or more wired or wireless network interfaces 704, one or more input/output interfaces 705, one or more keyboards 706, and the like.

In some implementations, the computer program code analysis device includes a storage and one or more programs. The one or more programs are stored in the storage, and the one or more programs can include one or more modules. Each module can include a series of computer-executable instructions in the computer program code analysis device. The one or more programs are configured to be executed by the one or more processors, and include computer-executable instructions for performing the following: obtaining an analysis task for performing computer program code analysis on a computer program code; determining, in a relational database based on a code structure type corresponding to the analysis task, a data table that stores code structure data of the computer program code in the code structure type; reading code structure data and a data structure relationship from the data table, to obtain the code structure data and the data structure relationship; and performing analysis processing on the code structure data and the data structure relationship in a computer program code analysis manner corresponding to the analysis task, to obtain a computer program code analysis result.

One or more implementations of a storage medium provided in the present specification are as follows:

Corresponding to the described computer program code analysis method, based on a same technical concept, one or more implementations of the present specification further provide a storage medium.

The storage medium provided in this implementation is configured to store computer-executable instructions, and the computer-executable instructions are executed by a processor to implement the following procedure: obtaining an analysis task for performing computer program code analysis on a computer program code; determining, in a relational database based on a code structure type corresponding to the analysis task, a data table that stores code structure data of the computer program code in the code structure type; reading code structure data and a data structure relationship from the data table, to obtain the code structure data and the data structure relationship; and performing analysis processing on the code structure data and the data structure relationship in a computer program code analysis manner corresponding to the analysis task, to obtain a computer program code analysis result.

It should be noted that the implementations of the storage medium in the present specification and the implementations of the computer program code analysis method in the present specification are based on a same invention concept. Therefore, reference can be made to the implementation of the corresponding method. Details are omitted.

The implementations in the present specification are described in a progressive manner. For same or similar parts in the implementations, reference can be made to each other. Each implementation focuses on a difference from other implementations. For example, the apparatus implementation, the device implementation, and the storage medium implementation are all similar to the method implementation. Therefore, description is simple. For related content in the apparatus implementation, the device implementation, and the storage medium implementation, reference can be made to the part of the method implementation.

The above describes example implementations of the present specification. Other implementations fall within the scope of the appended claims. In some cases, the actions or steps described in the claims can be performed in different order than in the implementations and can still achieve the expected results. In addition, the process depicted in the accompanying drawings does not necessarily require the shown particular order or sequence to achieve the desired results. In some implementations, multi-task processing and parallel processing are feasible or can be advantageous.

In the 1930s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the programmable logic device is determined by a user through device programming. The designer performs programming to “integrate” a digital system to a PLD without requesting a chip manufacturer to design and produce an application-specific integrated circuit chip. In addition, at present, instead of manually manufacturing an integrated circuit chip, such programming is mostly implemented by using “logic compiler” software. The logic compiler software is similar to a software compiler used to develop and write a program. Original code is to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. It should also be clear to a person skilled in the art that a hardware circuit that implements a logical method procedure can be readily obtained once the method procedure is logically programmed by using the several hardware description languages described above and is programmed into an integrated circuit.

A controller can be implemented in any suitable manner, for example, the controller can use a form such as a microprocessor, a processor, or a computer-readable medium, a logic gate, a switch, an application-specific integrated circuit (ASIC), a programmable logic controller, or an embedded microcontroller storing computer-readable computer program code (such as software or firmware) that can be executed by the (micro)processor. Examples of the controller include but are not limited to the following microcontrollers: ARC 625D, Atmel AT91SAM, Microchip PIC18F26K20, and Silicone Labs C8051F320. A storage controller can also be implemented as a part of control logic of the storage. A person skilled in the art also knows that in addition to implementing the controller by using only the computer-readable computer program code, logic programming can be performed on method steps to enable the controller to implement the same function in a form of a logic gate, a switch, an application specific integrated circuit, a programmable logic controller, or an embedded microcontroller. Therefore, the controller can be considered as a hardware component, and an apparatus configured to implement various functions in the controller can also be considered as a structure in the hardware component. Or the apparatus configured to implement various functions can even be considered as both a software module implementing the method and a structure in the hardware component.

The system, apparatus, module, or unit described in the implementations can be implemented by a computer chip or an entity, or can be implemented by a product that has a function. A typical implementation device is a computer. For example, the computer can be, for example, a personal computer, a laptop computer, a cellular phone, a camera phone, a smartphone, a personal digital assistant, a media player, a navigation device, an email device, a game console, a tablet computer, or a wearable device, or a combination of any of these devices.

For ease of description, the apparatus is described by dividing functions into various units. Certainly, when the implementations of the present specification are implemented, functions of the units can be implemented in one or more pieces of software and/or hardware.

A person skilled in the art should understand that one or more implementations of the present specification can be provided as methods, systems, or computer program products. Therefore, the one or more implementations of the present specification can use a form of hardware only implementations, software only implementations, or implementations with a combination of software and hardware. Moreover, the present specification can use a form of a computer program product that is implemented on one or more computer-usable storage media (including but not limited to a disk memory, a CD-ROM, an optical memory, etc.) that include computer-usable computer program code.

The present specification is described with reference to the flowcharts and/or block diagrams of the methods, the devices (systems), and the computer program products based on the implementations of the present specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a specific function in one or more processes in the flowcharts and/or in one or more blocks in the block diagrams.

In some implementations, these computer program instructions can be stored in a computer-readable storage that can instruct a computer or another programmable data processing device to work in a specific manner, so the instructions stored in the computer-readable storage generate an artifact that includes an instruction apparatus. The instruction apparatus implements a specific function in one or more procedures in the flowcharts and/or in one or more blocks in the block diagrams.

In some implementations, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more central processing units (CPU), input/output interfaces, network interfaces, and memories. The one or more processors may be configured to individually or collectively conduct actions to implement the methods provided herein. When the one or more processors collectively conduct actions, they may or may not conduct the same action or same part of an action at a same time and they may conduct different actions or different parts of an action collectively.

The one or more memory devices may be configured to individually or collectively store computer executable instructions to enable the methods provided herein. When the one or more memory devices collectively store computer executable instructions, they may or may not store the same instruction or same part of an instruction at a same time and they may store different instructions or different parts of an instruction collectively.

The memory can include a non-persistent memory, a random access memory (RAM), a non-volatile memory, and/or another form that are in a computer-readable medium, for example, a read-only memory (ROM) or a flash memory (flash RAM). The memory is an example of the computer-readable medium.

The computer-readable medium includes persistent, non-persistent, removable, and non-removable media that can store information by using any method or technology. The information can be computer-readable instructions, a data structure, a program module, or other data. Examples of a computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a magnetic cassette, a magnetic tape/magnetic disk storage or another magnetic storage device, or any other non-transmission medium that can be used to store information that can be accessed by a computing device. As described in the present specification, the computer-readable medium does not include computer-readable transitory media such as a modulated data signal and a carrier.

It should also be noted that the terms “include”, “comprise”, or any other variants thereof are intended to cover a non-exclusive inclusion, so that a process, a method, a product, or a device that includes a list of elements not only includes those elements but also includes other elements that are not expressly listed, or further includes elements inherent to such a process, method, product, or device. Without more constraints, an element preceded by “includes a . . . ” does not preclude the existence of additional identical elements in the process, method, product, or device that includes the element.

One or more implementations of the present specification can be described in a general context of computer-executable instructions executed by a computer, such as a program module. Generally, the program module includes a routine, a program, an object, a component, a data structure, etc. for executing a specific task or implementing a specific abstract data type. In some implementations, the one or more implementations of the present specification can be practiced in distributed computing environments. In the distributed computing environments, tasks are performed by remote processing devices connected through a communication network. In the distributed computing environments, the program module can be located in local and remote computer storage media including storage devices.

The implementations of the present specification are described in a progressive manner. For same or similar parts of the implementations, mutual references can be made to the implementations. Each implementation focuses on a difference from the other implementations. Particularly, the system implementations are basically similar to the method implementations, and therefore are described briefly. For related parts, references can be made to some descriptions of the method implementations.

The descriptions are merely implementations of the present specification and are not intended to limit the present specification. A person skilled in the art can make various changes and variations to the present specification. Any modification, equivalent replacement, improvement, etc. made without departing from the spirit and principle of the present specification shall fall within the scope of the claims in the present specification.

The various embodiments described above can be combined to provide further embodiments. All of the U.S. patents, U.S. patent application publications, U.S. patent applications, foreign patents, foreign patent applications listed in the Application Data Sheet are incorporated herein by reference, in their entirety. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer program code analysis method, comprising:
obtaining an analysis task for performing computer program code analysis on a computer program code;
determining, in a relational database based on a code structure type corresponding to the analysis task, a data table that stores code structure data of the computer program code in the code structure type;
obtaining the code structure data and a data structure relationship from the data table; and
performing analysis processing on the code structure data and the data structure relationship in a computer program code analysis manner corresponding to the analysis task, to obtain a computer program code analysis result.

2. The computer program code analysis method according to claim 1, wherein the determining the data table includes determining a plurality of data tables, and a field relationship in each of the plurality of data tables is determined based on a field structure configuration of the code structure type; and
a table relationship between the plurality of data tables is determined based on a code structure configuration of the code structure type.

3. The computer program code analysis method according to claim 1, comprising writing the code structure data in the data table, including:
reading a plurality of reference data tables in the code structure type; and
based on a data category of each of the plurality of reference data tables, reading code structure data from the computer program code and writing the code structure data into each reference data table.

4. The computer program code analysis method according to claim 3, comprising creating the plurality of reference data tables, including:
performing code extraction in a source computer program code based on the code structure type to obtain a key computer program code;
extracting a code category of each code snippet in the key computer program code;
creating the plurality of reference data tables based on the code category; and
constructing a table relationship between the plurality of reference data tables based on a snippet structure relationship of each code snippet in the source computer program code.

5. The computer program code analysis method according to claim 4, wherein the creating the plurality of reference data tables based on the code category includes:
performing deduplication processing on the code category to obtain a key code category;
performing combination processing on the key code category based on a syntax structure, to obtain at least one data category; and
creating a reference data table of each of the at least one data category.

6. The computer program code analysis method according to claim 1, further comprising:
before the determining, in the relational database based on the code structure type corresponding to the analysis task, the data table that stores the code structure data of the computer program code in the code structure type,
reading a reference data table pre-created in each code structure type;
based on a data category of the reference data table, reading code structure data from the computer program code and writing the code structure data into the reference data table, to obtain a data table in each code structure type; and
storing the data table in each code structure type in the relational database.

7. The computer program code analysis method according to claim 1, further comprising:
before the obtaining the analysis task for performing computer program code analysis on the computer program code,
obtaining an analysis instruction for performing computer program code analysis on the computer program code;
reading the analysis task included in the analysis instruction, and determining the code structure type corresponding to the analysis task; and
writing data into a plurality of reference data tables in the code structure type based on the computer program code, to obtain data tables in the code structure type, and storing the data tables in the relational database.

8. The computer program code analysis method according to claim 1, wherein the obtaining the analysis task for performing computer program code analysis on the computer program code includes:
obtaining instruction code corresponding to an interface call instruction for performing computer program code analysis on the computer program code, wherein the instruction code is written based on a first program language;
performing code conversion on the instruction code to obtain analysis instruction code that includes the analysis task, wherein the analysis instruction code is in a second program language; and
determining the analysis task based on the analysis instruction code.

9. The computer program code analysis method according to claim 1, wherein in response to the computer program code analysis manner being a static analysis manner, the performing analysis processing on the code structure data and the data structure relationship in the computer program code analysis manner corresponding to the analysis task, to obtain the computer program code analysis result includes:
reading a computer program code analysis policy corresponding to the analysis task;
performing static computer program code analysis on the code structure data and the data structure relationship based on the computer program code analysis policy, to obtain a static computer program code analysis result; and
generating the computer program code analysis result of the computer program code based on the static computer program code analysis result.

10. The computer program code analysis method according to claim 1, wherein in response to the computer program code analysis manner being a dynamic analysis manner, the performing analysis processing on the code structure data and the data structure relationship in the computer program code analysis manner corresponding to the analysis task, to obtain the computer program code analysis result includes:
performing code simulation running based on the code structure data and the data structure relationship; and
generating the computer program code analysis result of the computer program code based on a running result of the code simulation running.

11. The computer program code analysis method according to claim 1, wherein in response to the analysis task being a call analysis task, the reading the code structure data and the data structure relationship from the data table, to obtain the code structure data and the data structure relationship includes:
reading call data and called data from a function call data table of the computer program code in a function call type based on a call function identifier included in the call analysis task; and
constructing a data call relationship between the call data and the called data based on a call relationship between the call data and the called data in the function call data table.

12. A computer program code analysis device, comprising:
one or more processors and one or more storage devices, to the one or more storage devices, individually or collectively, having computer-executable instructions stored thereon, the computer-executable instructions, when executed by the one or more processors, enabling the one or more processors to, individually or collectively, perform actions including:
obtaining an analysis task for performing computer program code analysis on a computer program code;
determining, in a relational database based on a code structure type corresponding to the analysis task, a data table that stores code structure data of the computer program code in the code structure type;
obtaining the code structure data and a data structure relationship from the data table; and
performing analysis processing on the code structure data and the data structure relationship in a computer program code analysis manner corresponding to the analysis task, to obtain a computer program code analysis result.

13. The device according to claim 12, wherein the determining the data table includes determining a plurality of data tables, and a field relationship in each of the plurality of data tables is determined based on a field structure configuration of the code structure type; and
a table relationship between the plurality of data tables is determined based on a code structure configuration of the code structure type.

14. The device according to claim 12, wherein the actions include writing the code structure data in the data table, including:
reading a plurality of reference data tables in the code structure type; and
based on a data category of each of the plurality of reference data tables, reading code structure data from the computer program code and writing the code structure data into each reference data table.

15. The device according to claim 14, wherein the actions include creating the plurality of reference data tables, including:
performing code extraction in a source computer program code based on the code structure type to obtain a key computer program code;
extracting a code category of each code snippet in the key computer program code;
creating the plurality of reference data tables based on the code category; and
constructing a table relationship between the plurality of reference data tables based on a snippet structure relationship of each code snippet in the source computer program code.

16. The device according to claim 15, wherein the creating the plurality of reference data tables based on the code category includes:
performing deduplication processing on the code category to obtain a key code category;
performing combination processing on the key code category based on a syntax structure, to obtain at least one data category; and
creating a reference data table of each of the at least one data category.

17. The device according to claim 12, wherein the actions further include:
before the determining, in the relational database based on the code structure type corresponding to the analysis task, the data table that stores the code structure data of the computer program code in the code structure type,
reading a reference data table pre-created in each code structure type;
based on a data category of the reference data table, reading code structure data from the computer program code and writing the code structure data into the reference data table, to obtain a data table in each code structure type; and
storing the data table in each code structure type in the relational database.

18. The device according to claim 12, wherein the actions further include:
before the obtaining the analysis task for performing computer program code analysis on the computer program code,
obtaining an analysis instruction for performing computer program code analysis on the computer program code;
reading the analysis task included in the analysis instruction, and determining the code structure type corresponding to the analysis task; and
writing data into a plurality of reference data tables in the code structure type based on the computer program code, to obtain data tables in the code structure type, and storing the data tables in the relational database.

19. The device according to claim 12, wherein the obtaining the analysis task for performing computer program code analysis on the computer program code includes:
obtaining instruction code corresponding to an interface call instruction for performing computer program code analysis on the computer program code, wherein the instruction code is written based on a first program language;
performing code conversion on the instruction code to obtain analysis instruction code that includes the analysis task, wherein the analysis instruction code is in a second program language; and
determining the analysis task based on the analysis instruction code.

20. A storage medium having computer-executable instructions stored thereon, the computer-executable instructions, when executed by one or more processors, enabling the one or more processors to, individually or collectively, perform actions including:
obtaining an analysis task for performing computer program code analysis on a computer program code;
determining, in a relational database based on a code structure type corresponding to the analysis task, a data table that stores code structure data of the computer program code in the code structure type;
obtaining the code structure data and a data structure relationship from the data table; and
performing analysis processing on the code structure data and the data structure relationship in a computer program code analysis manner corresponding to the analysis task, to obtain a computer program code analysis result.
